(19) United States
(12) Patent Application Publication
(10) Pub. No.: US 2008/0172609 A1
(43) Pub. Date: Jul. 17, 2008

(54) MULTIPLE APPLICATION HANDLING

(75) Inventor: Markku RYTIVAARA, Oulu (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/622,147

(22) Filed: Jan. 11, 2007

(51) Int. Cl. G06F 3/00

(52) U.S. Cl. 715/700

(57) ABSTRACT

A user is provided with a simple way of selecting a number of “favourite” applications to be visible on the display of, e.g., his/her communication terminal or PDA. By customizing the apparatus in this manner the user will find it easier and more convenient to make full use of his/her device when doing business as well as utilizing the device when performing more leisure like activities.

### TECHNICAL FIELD

The disclosed embodiments relate to handling multiple software applications in an apparatus having a user interface.

### BACKGROUND

Present day mobile communication devices have evolved from a first generation of mobile telephones that were capable of not much more than conveying voice conversations in real time. Now the devices are capable of communicating in packet switched high speed digital mobile networks and capable of processing and presenting data in much the same manner as a typical personal computer. The field of use now includes a diverse number of types of applications, among which rendering of multimedia content, games and electronic commerce are but a few examples. In fact, the terminology is now such that a mobile communication device may include any type of personal digital assistant (PDA) apparatus or so-called smart-phone.

This diverse functionality requires, not least, a capability of providing an easy to use user interface. However, this is an often neglected problem. Many devices, although they offer very diverse functionality and a large number of different user applications, are in fact difficult to use and many users do not make full use of devices that, ideally, should be able to facilitate for users when doing business as well as utilizing the device when performing more leisure like activities.

### SUMMARY

In order to improve on already existing solutions with regard to the handling of multiple applications in an apparatus having a user interface, in one aspect there is provided a method in a user interface for controlling initiation of multiple software applications. The method comprises detecting a first triggering signal, and in response to the first triggering signal entering an application selection mode. During the application selection mode, a plurality of selection signals are detected, each selection signal being indicative of a respective software application to be initiated. The application selection mode is exited, and each selected software application is initiated, during which initiation at least a subset of the plurality of selected software applications concurrently displays information.

In another aspect, there is provided a method in a user interface for controlling initiation of multiple software applications. The method comprises detecting a first triggering signal, and in response to the first triggering signal entering an application selection mode. During the application selection mode, a plurality of selection signals are detected, each selection signal being indicative of a respective software application to be initiated. The application selection mode is exited, and a control application is generated and stored, the control application being configured to be executed on demand and configured such that during execution performs initiation of each selected software application.

In other aspects, there are provided computer-readable medium having computer-executable components comprising instructions to perform such methods.

An apparatus, in another aspect, comprises a processor, a memory unit and user interface units including a display and a keypad. These are configured to detect a first triggering signal, and in response to the first triggering signal set the apparatus in an application selection mode, detect, during the application selection mode, a plurality of selection signals, each selection signal being indicative of a respective software application to be initiated, make the apparatus exit the application selection mode, and initiate each selected software application, during which initiation at least a subset of the plurality of selected software applications concurrently displays information.

Another apparatus, in yet another aspect, comprises a processor, a memory unit and user interface units including a display and a keypad. These are configured to detect a first triggering signal, and in response to the first triggering signal set the apparatus in an application selection mode, detect, during the application selection mode, a plurality of selection signals, each selection signal being indicative of a respective software application to be initiated, make the apparatus exit the application selection mode, and generate and store a control application, the control application being configured to be executed on demand and configured such that during execution performs initiation of each selected software application.

In other words, these methods and apparatuses provide, in different aspects, a user with a simple way of selecting a number of “favourite” applications to be visible on the display of, e.g., his/her communication terminal or PDA. By customizing the apparatus in this manner the user will find it easier and more convenient to make full use of his/her device when doing business as well as utilizing the device when performing more leisure like activities.

Embodiments include those where the detection of the first triggering signal is performed in an shell application, in which shell application a plurality of graphical symbols are displayed at respective predetermined positions, and wherein the detection of the selection signals comprises detection of position information associated with the graphical symbols. The symbol positions may be associated with respective keypad key positions, and the detection of the selection signals may comprise detection of keypad key position information.

That is, an even more user friendly way to enable selection of multiple applications is to make use of a correlation between positions of graphical symbols, e.g. so-called icons, and positions of, e.g. keys on a keypad.

Embodiments include those where a control application is generated and stored, the control application being configured to be executed on demand and configured such that during execution performs the initiation of each selected software application. Information representing a graphical symbol associated with the control application may be generated and stored.

In such embodiments, a selected set or group of applications can itself be considered as an “extended application” and called on at any time to provide an immediate setup of the “favourite” applications.

Embodiments include those where the exiting of the application selection mode depends on a detection of a second triggering signal.

Such embodiments facilitate the process of selection of the applications to be initiated in that an explicit signal, i.e. the second triggering signal, is generated, for example by the user pressing a key, to signal that the selection process is completed.

The concurrent displaying of information by the selected software applications may, in embodiments, be performed in a respective display area and the displaying in display areas may involve displaying in non-overlapping display areas.

In such embodiments, by dividing the total available display area into sub-areas in which the selected applications, respectively, displays information, the user is provided with a logical and lucid overview of the selected applications.

Embodiments include those where the software applications comprise any of a media player application, a chat application, a messaging application, a calendar application, an image recording application.

These embodiments reflect the advantage that is provided by allowing functionally very different applications to be available for use simultaneously. A user may desire to have easy and immediate access to a messaging application while virtually at the same time manipulating a music player application.

### BRIEF DESCRIPTION OF THE DRAWINGS

FIG. 1 shows schematically a block diagram of a communication terminal according to the disclosed embodiments.

FIG. 2 is a flow chart illustrating a number of steps of a method according to the disclosed embodiments.

FIGS. 3a-f illustrate in a schematic way the appearance of a display during operation of the method of FIG. 2.

### DETAILED DESCRIPTION OF EMBODIMENTS

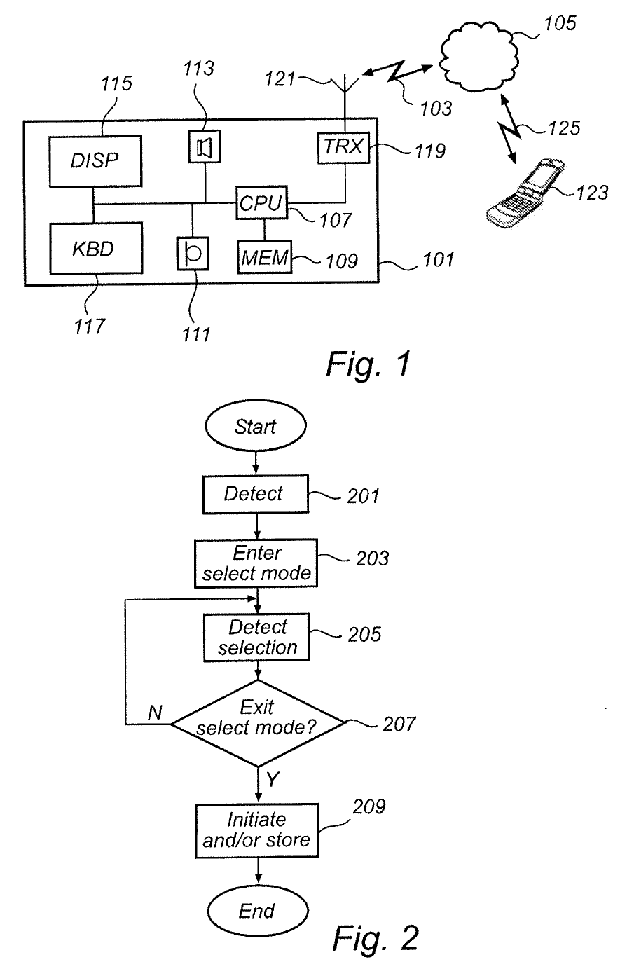

FIG. 1 illustrates schematically an apparatus in the form of a communication terminal 101 in which the aspects of the claimed invention are embodied. The terminal 101 is capable of communication via an air interface 103 with a radio communication system 105 such as the well known systems GSM/GPRS, UMTS, CDMA 2000 etc. The terminal comprises a processor 107, memory 109 as well as input/output units in the form of a microphone 111, a speaker 113, a display 115 and a keyboard 117. Radio communication is realized by radio circuitry 119 and an antenna 121. The details regarding how these units communicate are known to the skilled person and is therefore not discussed further.

The communication terminal 101 may for example be a mobile telephone terminal, a smart-phone or a PDA etc., equipped with radio communication means. The method to be described below will in general reside in the form of software instructions, together with other software components that are required for the operation of the terminal 101, in the memory 109 of the terminal 101. The software instructions of the method to be described may be provided into the memory 109 in a number of ways, including distribution via the network 105 from a software supplier 123 as well as being embodied on a computer readable medium such as a memory card forming part of the memory 109.

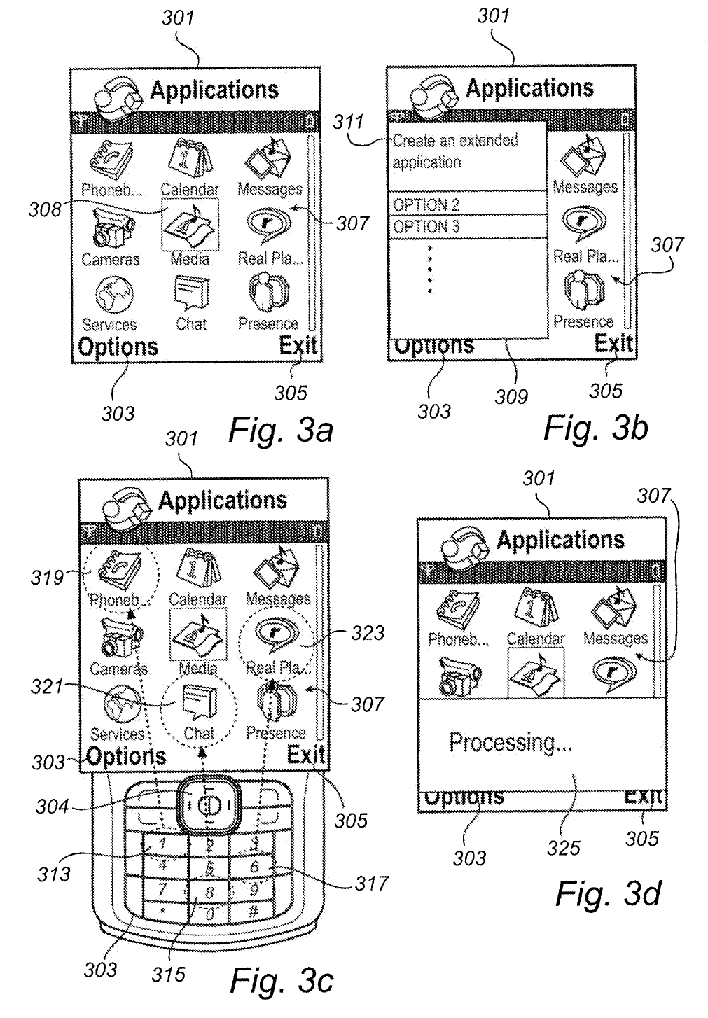

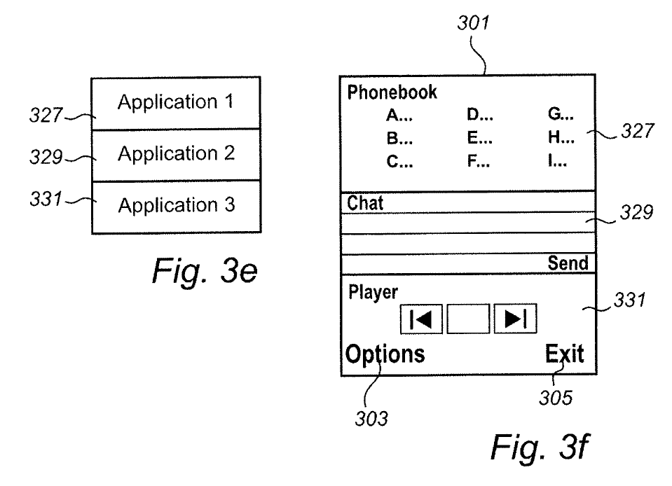

Turning now to FIGS. 2 and 3a-f, a method according to the invention will be described in terms of a number of steps to be taken by controlling software in a terminal such as the terminal 101 described above in connection with FIG. 1. FIG. 2 is a flow chart of the method and FIGS. 3a-f depict a display 301 of a terminal having a keypad 303. It is to be noted that although only FIG. 3c illustrates a terminal keypad 303, it is to be understood that reference to the keypad 303 will be made also in the description of FIGS. 3a-b and 3d-f.

A user interacts with the terminal using so-called soft keys as illustrated in FIGS. 3a-f by way of two keys 303, 305 located in the lower part of the display 301. The soft keys 303, 305 are labelled “Options” and “Exit”, respectively, and indicate specific operations that are to be executed by the terminal controller when a corresponding (i.e. most adjacent) keypad key is pressed.

FIG. 3a illustrates a situation in a user interface where an application shell, running in the terminal, is displaying a number of graphical symbols in the form of icons 307, each icon representing an application program or any other executable operation that the terminal is capable of performing. Selection of the operations or applications that are represented by the icons 307 is typically performed via user interface functions that highlight the icon, as exemplified by the highlighted “Media” icon 308. By user manipulation of the keypad 303, for example by means of a joystick key 304, other icons may be highlighted. Activation of the operation or application that is represented by the highlighted icon 308 is also performed by way of user manipulation of, e.g., the joystick key 304.

In a detection step 201, a first triggering signal is detected. The triggering signal is generated when the user selects a first option 311 from an option menu 309, the appearance of which is a result of the user activating the “option” soft key 303. The actual selection of the first option 311 may be effectuated by manipulation of the joystick 304.

In response to the detection of the triggering signal, the operation of the terminal enters 203 a selection mode in which a number of applications, represented on the display 301 by the icons 307, are to be grouped together such that they concurrently at least displays information.

The actual selection of the applications that are to be grouped together is performed in a detect and record step 205 and is illustrated in FIG. 3c.

Here, the user has decided to select three applications for grouping together: a first application 319, a second application 321 and a third application 323. By manipulation, in any sequential order, of a first keypad key 313, a second key 315 and a third key 317, the respective position of which on the keypad 303 correspond to the position of the respective representative icon on the display 301, a respective selection signal is produced. It is to be noted that the dashed lines and arrows in FIG. 3c are provided in order to illustrate the positional correspondence between the icons 319, 321, 323 and the keys 313, 315, 317.

Whether or not to exit the selection mode, is decided in a decision step 207. For example, after detection of three selection signals or after detection of an explicit exit triggering signal generated via the keypad 303, an indicator 325 may be displayed that informs the user that the selections are being analysed.

The selected applications are then initiated in an initiation step 209. The initiation may entail processing that sets up the display 301 by dividing it into three non-overlapping areas, a first area 327, a second area 329 and a third area 331 allocated to, respectively, the three selected applications (corresponding to icon 319, icon 321 and icon 323) that display application specific information in these three areas. The initiation may involve, in addition to or alternative to the allocation of the display areas, generation of an “extended application” that is recorded and made executable such it may be invoked at any later instant in time to perform the initiation of the selected applications.

As FIG. 3f illustrates, the display 301 is, after initiation of the three selected applications, displaying a phonebook application, a chat application and a media player application, which illustrates an improved user friendliness of the disclosed method and apparatus. For example, the user may, during listening to music by way of the media player application, simultaneously view a phonebook entry and/or take part in a chat session, without having to actively switch between different pages of the display.

1. A method in a user interface for controlling: initiation of multiple software applications, comprising:
detecting a first triggering signal, and in response to the first triggering signal entering an application selection mode,
detecting, during the application selection mode, a plurality of selection signals, each selection signal being indicative of a respective software application to be initiated,
exiting the application selection mode, and
initiating each selected software application, during which initiation at least a subset of the plurality of selected software applications concurrently displays information.

2. The method of claim 1, wherein the detection of the first triggering signal is performed in a shell application, in which shell application a plurality of graphical symbols are displayed at respective predetermined positions, and wherein the detection of the selection signals comprises detection of position information associated with the graphical symbols.

3. The method of claim 2, wherein the symbol positions are associated with respective keypad key positions, and wherein the detection of the selection signals comprises detection of keypad key position information.

4. The method of claim 1, further comprising generating and storing of a control application, the control application being configured to be executed on demand and configured such that during execution performs the initiation of each selected software application.

5. The method of claim 4, further comprising generating and storing information representing a graphical symbol associated with the control application.

6. The method of claim 1, wherein the exiting of the application selection mode depends on a detection of a second triggering signal.

7. The method of claim 1, wherein the concurrent displaying of information by the selected software applications is performed in a respective display area.

8. The method of claim 7, wherein the displaying in display areas involves displaying in non-overlapping display areas.

9. The method of claim 1, wherein the software applications comprise any of:
a media player application,
a chat application,
a messaging application,
a calendar application,
an image recording application.

10. A method in a user interface for controlling initiation of multiple software applications, comprising:
detecting a first triggering signal, and in response to the first triggering signal entering an application selection mode,
detecting, during the application selection mode, a plurality of selection signals, each selection signal being indicative of a respective software application to be initiated,
exiting the application selection mode, and
generating and storing of a control application, the control application being configured to be executed on demand and configured such that during execution performs initiation of each selected software application.

11. An apparatus comprising a processor, a memory unit and user interface units including a display and a keypad, configured to:
detect a first triggering signal, and in response to the first triggering signal set the apparatus in an application selection mode,
detect, during the application selection mode, a plurality of selection signals, each selection signal being indicative of a respective software application to be initiated,
make the apparatus exit the application selection mode, and
initiate each selected software application, during which initiation at least a subset of the plurality of selected software applications concurrently displays information.

12. The apparatus of claim 11, configured such that the detection of the first triggering signal is performed in a shell application, in which shell application a plurality of graphical symbols are displayed at respective predetermined positions, and configured such that the detection of the selection signals comprises detection of position information associated with the graphical symbols.

13. The apparatus of claim 12, configured such that the symbol positions are associated with respective keypad key positions, and configured such that the detection of the selection signals comprises detection of keypad key position information.

14. The apparatus of claim 11, further configured to generate and store a control application, the control application being configured to be executed on demand and configured such that during execution performs the initiation of each selected software application.

15. The apparatus of claim 14, further configured to generate and store information representing a graphical symbol associated with the control application.

16. The apparatus of claim 11, configured such that the exiting of the application selection mode depends on a detection of a second triggering signal.

17. The apparatus of claim 11, configured such that the concurrent displaying of information by the selected software applications is performed in a respective display area.

18. The apparatus of claim 17, configured such that the displaying in display areas involves displaying in non-overlapping display areas.

19. The apparatus of claim 11, configured such that the software applications comprise any of:
a media player application,
a chat application,
a messaging application,
a calendar application,
an image recording application.

20. An apparatus comprising a processor, a memory unit and user interface units including a display and a keypad, configured to:
detect a first triggering signal, and in response to the first triggering signal set the apparatus in an application selection mode,
detect, during the application selection mode, a plurality of selection signals, each selection signal being indicative of a respective software application to be initiated,
make the apparatus exit the application selection mode, and
generate and store a control application, the control application being configured to be executed on demand and configured such that during execution performs initiation of each selected software application.

21. A computer-readable medium having computer-executable components comprising instructions to perform a method according to claim 1.

22. A computer-readable medium having computer-executable components comprising instructions to perform a method according to claim 10.

23. An apparatus comprising a processor, a memory unit and user interface units including a display and a keypad, comprising means for:
detecting a first triggering signal, and in response to the first triggering signal entering an application selection mode,
detecting, during the application selection mode, a plurality of selection signals, each selection signal being indicative of a respective software application to be initiated,
exiting the application selection mode, and
initiating each selected software application, during which initiation at least a subset of the plurality of selected software applications concurrently displays information.

24. An apparatus comprising a processor, a memory unit and user interface units including a display and a keypad, comprising means for:
detecting a first triggering signal, and in response to the first triggering signal entering an application selection mode,
detecting, during the application selection mode, a plurality of selection signals, each selection signal being indicative of a respective software application to be initiated,
exiting the application selection mode, and
generating and storing of a control application, the control application being configured to be executed on demand and configured such that during execution performs initiation of each selected software application.
